(19) United States
(12) Patent Application Publication
(10) Pub. No.: US 2008/0186380 A1
(43) Pub. Date: Aug. 7, 2008

(54) SURVEILLANCE SYSTEM AND METHOD

(75) Inventors: Geng-Liang Zhang, Shenzhen (CN); Shih-Fang Wong, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/773,978

(22) Filed: Jul. 6, 2007

(30) Foreign Application Priority Data
Feb. 2, 2007 (CN) 200710200151.1

(51) Int. Cl. H04N 7/14

(52) U.S. Cl. 348/143; 348/E07.086

(57) ABSTRACT

A surveillance system includes a camera, a brightness detector, a light source, and a controller. The camera is used for capturing images of a monitored area, and generating captured images. The brightness detector is used for detecting brightness of the monitored area, and generating a brightness signal. The light source is used for emitting light to illuminate the monitored area. The controller is used for generating a light control signal according to the brightness signal. The light control signal is configured for controlling the light source. A surveillance method is also provided.

### BACKGROUND OF THE INVENTION

1. Field of the Invention

The present invention generally relates to surveillance systems and methods. Particularly, the present invention relates to a surveillance system and method capable of surveilling in a dim environment.

2. Description of Related Art

Surveillance systems are used in various fields, such as security systems, remote control vehicle guidance, medical monitoring, hazardous area monitoring, and so on.

Usually, a surveillance system includes a camera, a controller, and a memory. The camera is able to capture successive images from a monitored area and regenerate the captured images. The memory stores the captured images. The controller controls the camera and the memory. However, when a brightness of the monitored area is low, the surveillance system would be unable to capture images from the monitored area by using a common camera.

Therefore, an infrared camera is used because of its ability to detect infrared light of the monitored area. Although a surveillance system incorporating the infrared camera can capture images, there is still an obvious drawback existing in captured images in that the captured images are indistinct. Besides, the infrared camera is expensive, making the surveillance system also expensive.

### SUMMARY OF THE INVENTION

A surveillance system includes a camera, a brightness detector, a light source, and a controller. The camera is used for capturing images of a monitored area, and generating captured images. The brightness detector is used for detecting brightness of the monitored area, and generating a brightness signal. The light source is used for emitting light to illuminate the monitored area. The controller is used for generating a light control signal according to the brightness signal. The light control signal is configured for controlling the light source.

A surveillance method includes steps of: detecting brightness of a monitored area; projecting light to the monitored area according to the brightness of the monitored area; capturing images of the monitored area; and storing the image of the monitored area.

Other systems, methods, features, and advantages of the present surveillance system and method will be or become apparent to one with skill in the art upon examination of the following drawings and detailed description. It is intended that all such additional systems, methods, features, and advantages be included within this description, be within the scope of the present system and method, and be protected by the accompanying claims.

### BRIEF DESCRIPTION OF THE DRAWINGS

Many aspects of the present surveillance system and method can be better understood with reference to the following drawings. The components in the drawings are not necessarily to scale, emphasis instead being placed upon clearly illustrating the principles of the inventive system and method. Moreover, in the drawings, like reference numerals designate corresponding parts throughout the several views.

FIG. 1 is a block diagram of a surveillance system in accordance with an exemplary embodiment.

FIG. 2 is a block diagram of the controller of the surveillance system in accordance with an exemplary embodiment.

FIG. 3 is a block diagram of the controller of the surveillance system in accordance with an alternative exemplary embodiment.

FIG. 4 is a flowchart of a surveillance system according to a first exemplary embodiment.

FIG. 5 is a flowchart of a surveillance system according to a second exemplary embodiment.

FIG. 6 is a flowchart of a surveillance system according to a third exemplary embodiment.

### DETAILED DESCRIPTION OF THE INVENTION

Reference will now be made to the drawings to describe preferred embodiments of the present surveillance system and method.

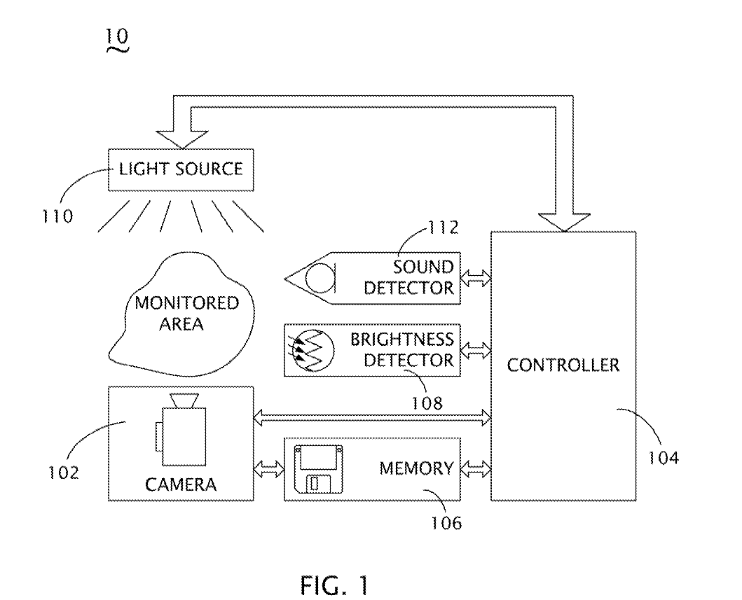

Referring to FIG. 1, a surveillance system 10 includes a camera 102, a controller 104, a memory 106, a brightness detector 108, a light source 110, and a sound detector 112.

The camera 102 is used for capturing images of a monitored area, and generating captured images accordingly. The captured images are transmitted to the controller 104, and the memory 106 in the form of binary data.

The controller 104 is used for controlling other components of the surveillance system 10.

The memory 106 is used for storing the captured images.

The brightness detector 108 is used for detecting brightness of the monitored area, and generating a brightness signal accordingly. The controller 104 is for receiving the brightness signal, and enabling or disabling the light source 110 according to the brightness signal.

The light source 110 is used for lighting the monitored area, so that the monitored area is bright enough for the camera 102 to capture the images. The light source 110 is enabled or disabled by the controller 104.

The sound detector 112 is used for detecting a noise intensity in the monitored area, and generating a noise level signal. The controller 104 is for receiving the noise level signal, and for signaling the memory 106 to store the captured images when the noise intensity is greater than a predetermined noise intensity.

In an alternative embodiment, the controller 104 is used for enabling the sound detector 112 when the brightness signal is lower than a predetermined brightness, and disabling the sound detector 112 when the brightness signal is greater than the predetermined brightness. In this embodiment, when the sound detector 112 is enabled to detect the noise intensity in the monitored area, the memory 106 is signaled by the controller 104 to store the captured images based on the noise level signal. When the brightness signal is greater than the predetermined brightness, the sound detector 112 is disabled, and the memory 106 can be enabled when objects in the monitored area are in motion states, and disabled when the objects in the monitored area are stationary.

In another alternative embodiment, the controller 104 enables or disables the light source 110 not only according to the brightness signal, but also according to the noise level signal. The light source 110 is turned on when the brightness of the monitored area is lower than the predetermined brightness, and at the same time the noise intensity in the monitored area is greater than the predetermined sound intensity. The noise level signal is used for controlling the light source 110 if the brightness of the monitored area is low. Since abnormal situations often occur with a lot of noise, the surveillance system in accordance with this embodiment thus avoids turning on the light source 110 all the time, saving energy.

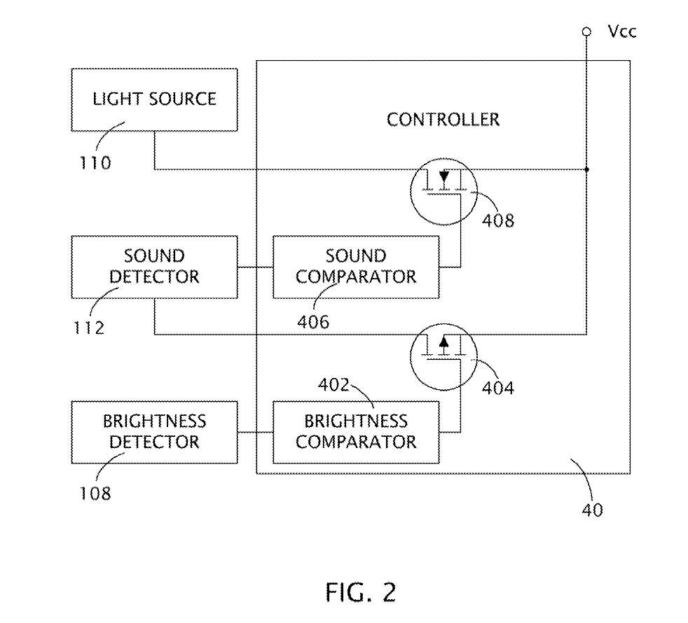

Referring to FIG. 2, a block diagram of the controller of the surveillance system in accordance with an exemplary embodiment is illustrated. The controller 10 includes brightness comparator 402, a first transistor 404, a sound comparator 406, and a second transistor 408.

The brightness comparator 402 is used for receiving the brightness signal sent from the brightness detector 108. The brightness comparator 402 compares the brightness signal with the predetermined brightness, and generates brightness-compared result. The brightness-compared result is sent to the first transistor 404.

The first transistor 404 is used for enabling the sound detector 112, when the brightness-compared result indicates that the brightness of the monitored area is less than the predetermined brightness.

Preferably, the first transistor 404 is a field effect transistor (FET). A source of the first transistor 404 is coupled to a power V_{CC}. A gate of the first transistor 404 is connected to the brightness comparator 402, for receiving the brightness-compared result. A drain of the first transistor 404 is connected to the sound detector 112. When the brightness signal is lower than the predetermined brightness value, the first transistor 404 is switched on based on the brightness-compared result. Thus, the sound detector 112 is enabled to operate. When the brightness signal is greater than the predetermined brightness, the first transistor 404 is switched off based on the brightness-compared result. Thus, the sound detector 112 is disabled.

The sound comparator 406 is used for comparing the noise level signal with the predetermined sound intensity, and generating a sound compared result. The sound compared result is sent to the second transistor 408.

The second transistor 408 is used for receiving the brightness signal, and turning on or turning off the light source 110 according to the sound compared result. When the sound compared result indicates that the noise intensity in the monitored area is greater than the predetermined sound intensity, the light source 110 is turned on.

Preferably, the second transistor 408 is a field effect transistor (FET). A source of the second transistor 408 is coupled to the power V_{CC} (not labeled). A gate of the second transistor 408 is connected to the sound comparator 406, for receiving the sound compared result. A drain of the second transistor 408 is connected to the light source 110. When the noise level signal is greater than the predetermined sound intensity value, the second transistor 408 is switched on based on the sound compared result. Thus, the light source 110 is turned on. When the noise level signal is lower than the predetermined sound intensity value, the second transistor 408 is switched off based on the sound compared result. Thus, the light source 110 is turned off.

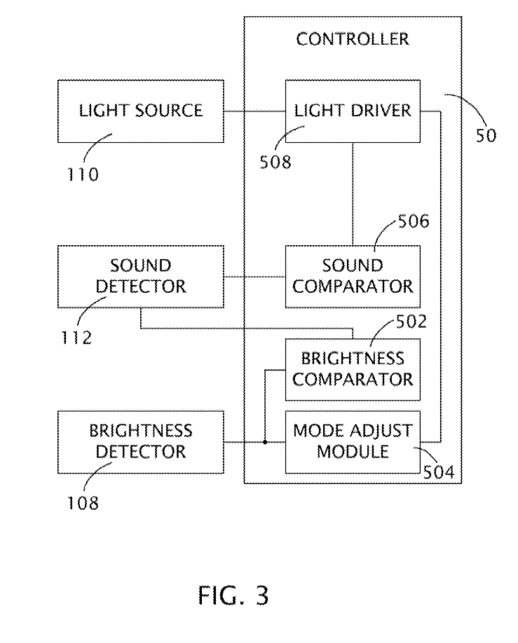

Referring to FIG. 3, a block diagram of the controller in accordance with another exemplary embodiment is illustrated. The controller 50 includes brightness comparator 502, a mode adjust module 504, a sound comparator 506, and a light driver 508.

The brightness comparator 502 is connected to the brightness detector 108, for receiving the brightness signal. The brightness comparator 502 compares the brightness signal with the predetermined brightness value, and generates the brightness-compared result accordingly. The brightness-compared result is sent to the sound detector 112, for enabling or disabling the sound detector 112.

The sound comparator 506 is connected to the sound detector 112, for receiving the noise level signal. The sound comparator 506 compares the noise level signal with the predetermined sound intensity, and generates the sound compared result according to the comparison. The sound compared result is also sent to the light driver 508.

The brightness signal generated by the brightness detector 108 is also sent to the mode adjust module 504. The mode adjust module 504 classifies the brightness signal, and determines brightness grades of the monitored area. The mode adjust module 504 sends a brightness grade signal to the light driver 508.

The light driver 508 is used for generating light drive signal according to the brightness grade signal and the sound compared sent from the mode adjust module 504 and the sound comparator 506, respectively. The light source 110 is thus driven by the light drive signal, and emits light with different brightness.

When the brightness of the monitored area is lower than the predetermined brightness value, the sound detector 112 is enabled. The sound detector 112 detects the noise intensity in the monitored area, and sends the noise level signal to the sound comparator 506. If the sound compared result indicates that the noise intensity in the monitored area is greater than the predetermined sound intensity value, the light driver 508 will drive the light source 110 to emit light with brightness corresponding to the grades.

In such an embodiment, the brightness signal is classified into a plurality of grades. The surveillance system 10 may thus be adjusted in a plurality of modes corresponding to the grades of the brightness signal, such as cloudy mode, sunny mode, night mode, and so on. The light source 110 is adjusted to emit light with different brightness in the different modes. The surveillance system in accordance with this embodiment thus avoids setting a fixed brightness of the light emitted by the light source 110, saving energy.

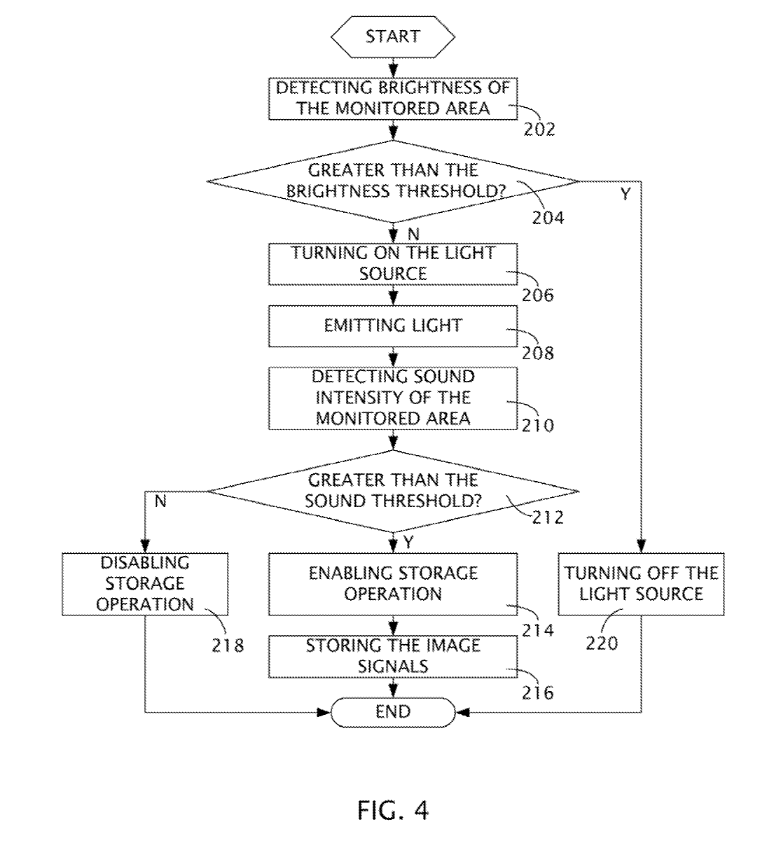

Referring to FIG. 4, a flowchart of a surveillance system according to an exemplary embodiment is illustrated. The surveillance system 10 as shown in FIG. 1 is incorporated in the following description, as an example.

Step 202, the brightness detector 108 detects the brightness of the monitored area, and generates the brightness signal. The brightness signal is transmitted to the controller 104.

Step 204, the controller 104 compares the brightness signal with the predetermined brightness value. If the brightness of the monitored area is not greater than the predetermined brightness, the procedure goes to step 206. If the brightness of the monitored area is greater than the predetermined brightness, the procedure goes to step 220.

Step 206, the controller 104 turns on the light source 110.

Step 208, the light source 110 emits light to illuminate the monitored area.

Step 210, the sound detector 112 detects the noise intensity in the monitored area, and generates a noise level signal. The noise level signal is transmitted to the controller 104.

Step 212, the controller 104 compares the noise level signal with the predetermined sound intensity value. If the noise intensity in the monitored area is greater than the predetermined sound intensity, the procedure goes to step 214. If the noise intensity in the monitored area is not greater than the predetermined sound intensity, the procedure goes to step 218.

Step 214, the controller 104 enables the storage operation of the memory 106.

Step 216, the memory 106 stores the captured images when the storage operation is enabled.

Step 218, the controller 104 disables the storage operation of the memory 106.

Step 220, the controller 104 turns off the light source 110.

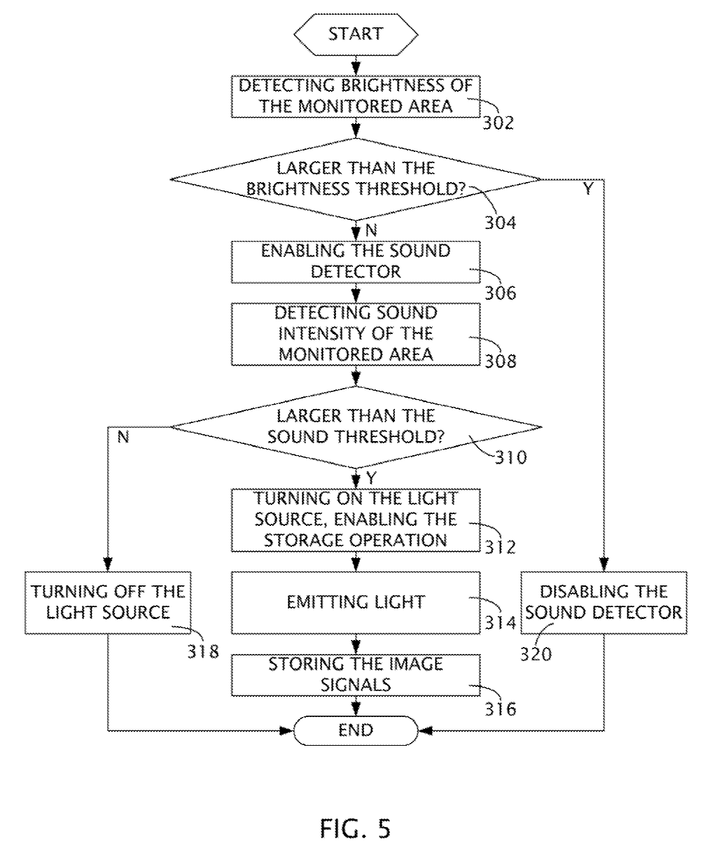

Referring to FIG. 5, a flowchart of the surveillance method in accordance with another exemplary embodiment is illustrated. The surveillance system 10 as shown in FIG. 1 is incorporated in the following description, as an example.

Step 302, the brightness detector 108 detects the brightness of the monitored area, and generates the brightness signal. The brightness signal is transmitted to the controller 104.

Step 304, the controller 104 compares the brightness signal with the predetermined brightness value. If the brightness of the monitored area is less than or equal to the predetermined brightness, the procedure goes to step 306. If the brightness of the monitored area is greater than the predetermined brightness, the procedure goes to step 320.

Step 306, the controller 104 enables the sound detector 112.

Step 308, the sound detector 112 detects the noise intensity in the monitored area, and generates the noise level signal. The noise level signal is transmitted to the controller 104.

Step 310, the controller 104 compares the noise level signal with the predetermined sound intensity. If the noise intensity in the monitored area is no less than the predetermined sound intensity, the procedure goes to step 312. If the noise intensity in the monitored area is less than the predetermined sound intensity, the procedure goes to step 318.

Step 312, the controller 104 turns on the light source 110. The controller 104 further enables the memory 106.

Step 314, the light source 110 emits light to illuminate the monitored area.

Step 316, the memory 106 stores the captured image.

Step 318, the controller 104 turns off the light source 110. At this situation, the storage operation of the memory 106 may be controlled depends on the motion or stationary state of the objects in the monitored area.

Step 320, the controller 104 disables the sound detector 112. The storage operation of the memory 106 may be controlled depending on the motion or stationary state of the objects in the monitored area, in this situation.

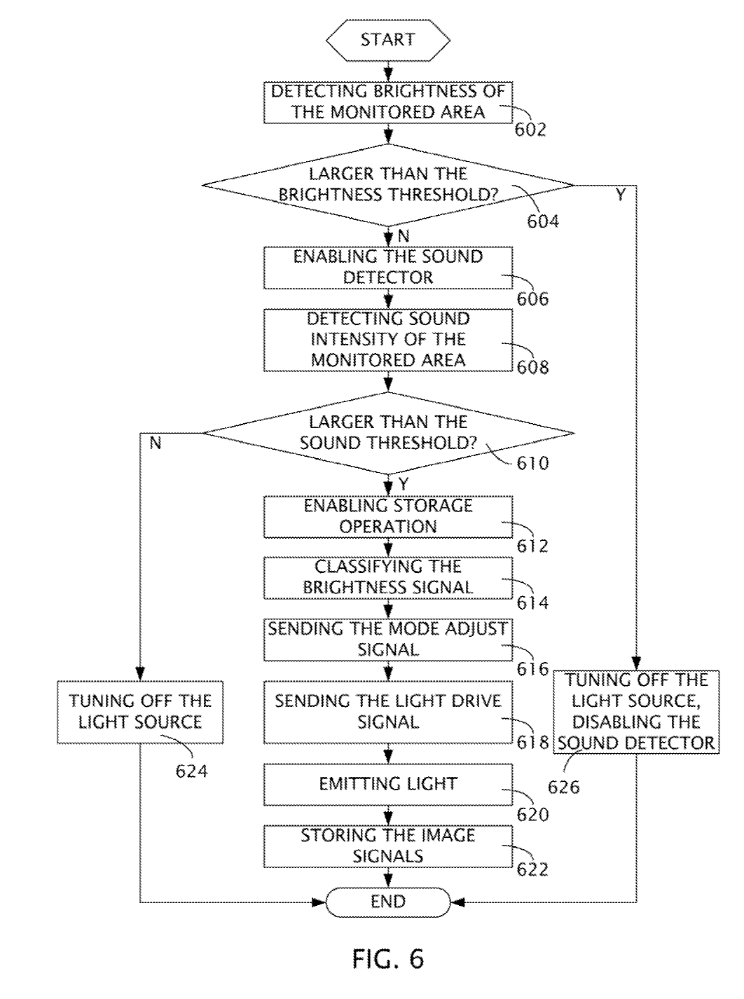

Referring to FIG. 6, a flowchart of the surveillance method in accordance with another exemplary embodiment is illustrated. The controller 50 as shown in FIG. 3 is incorporated in the following description, as an example.

Step 602, the brightness detector 108 detects the brightness of the monitored area, and generates the brightness signal. The brightness signal is transmitted to the controller 50.

Step 604, the brightness comparator 502 of the controller compares the brightness signal with the predetermined brightness value, and generates the brightness-compared result according to the comparison.

Step 606, if it is concluded from the brightness-compared result that the brightness of the monitored area is less than or equal to the predetermined brightness, the sound detector 112 is enabled according to the brightness-compared result.

Step 608, the sound detector 112 detect the noise intensity in the monitored area, and generates the noise level signal. The noise level signal is sent to the sound comparator 506.

Step 610, the sound comparator 506 compares the noise level signal with the predetermined sound intensity, and generates the sound compared result according to the comparison. The sound compared result is sent to the light driver 508.

Step 612, if it is concluded from the sound compared result that the noise intensity in the monitored area is no less than the predetermined sound intensity value, the controller 50 enables the storage operation of the memory 106.

Step 614, the mode adjust module 504 receives the brightness signal, and classifies the brightness signal, for determining brightness grades of the monitored area, and generate a brightness grade signal.

Step 616, the mode adjust module 504 sends the brightness grade signal to the light driver 508.

Step 618, if it is concluded from the sound compared result that the noise intensity in the monitored area is no less than the predetermined sound intensity value, the light driver 508 generates the light drive signal according to the brightness grade signal sent from the mode adjust module 504. The light drive signal is sent to the light source 110.

Step 620, the light source 110 emits light with brightness corresponding to the brightness of the monitored area, according to the light drive signal sent from the light driver 508. The light emitted by the light source 110 illuminates the monitored area, thus the brightness of the monitored area is enough to be captured by the camera 102. The camera 102 regenerates captured images, and sends the captured images to the memory 106.

Step 622, the memory 106 stores the captured images when the storage operation is enabled.

Step 624, if it is concluded from the sound compared result that the noise intensity in the monitored area is less than the predetermined sound intensity value, the light driver 508 generates the light drive signal according to the brightness grade signal sent from the mode adjust module 504. The light drive signal is used for tuning off the light source 110. The storage operation of the memory 106 may be controlled depending on the motion or stationary state of the objects in the monitored area, in this situation.

Step 626, if it is concludes from the brightness-compared result that the brightness of the monitored area is greater than the predetermined brightness, the light driver 508 of the controller 50 generates the light drive signal, and sends the light drive signal to the light source 110. The light drive signal is used for turning off the light source 100. The brightness-compared result is transmitted to the sound detector 112, and disables the sound detector 112. At this situation, the storage operation of the memory 106 may be controlled depends on the motion or stationary state of the objects in the monitored area.

The surveillance system and method determines whether to use the light source to illuminate the monitored area according to the brightness of the monitored area. When the brightness of the monitored area is not enough for being clearly captured by the camera, the light source is turning on, thus the monitored area would have a sufficient brightness.

The surveillance system and method utilizes the sound detector to detect the noise intensity in the monitored area, and determines whether to turn on the light source according to the noise intensity in the monitored area. This avoids turning on the light source all the time when the brightness of the monitored area is insufficient, thereby saving energy. The storage operation of the memory is also dependant on the noise intensity in the monitored area, thus avoiding storing a lot of useless captured images, thereby memory space is effectively used.

The surveillance system and method in accordance with the embodiments is able to illuminate the monitored area with brightness of different grades corresponding to the brightness of the monitored area, avoiding the brightness of the light source is set at a highest level, thereby saving energy.

What is claimed is:

1. A surveillance system comprising:
a camera for capturing images of a monitored area, and generating captured images;
a brightness detector for detecting brightness of the monitored area, and generating a brightness signal;
a light source for emitting light to illuminate the monitored area; and
a controller for controlling the light source based on the brightness.

2. The surveillance system as claimed in claim 1, wherein the controller comprises brightness comparator, the brightness comparator being configured for comparing the brightness signal with a predetermined brightness, and generating brightness-compared result; the light source is turned on if the brightness-compared result indicates that the brightness of the monitored area is lower than the predetermined brightness.

3. The surveillance system as claimed in claim 1, wherein:
the surveillance system further comprises a sound detector for detecting a noise intensity in the monitored area, and generating a noise level signal; and the controller comprises a sound comparator for comparing the noise level signal with a predetermined sound intensity, and generating a sound compared result; the light source is turned on if the sound compared result indicates that the noise intensity in the monitored area is greater than the predetermined sound intensity.

4. The surveillance system as claimed in claim 3, further comprising a memory for storing the captured images.

5. The surveillance system as claimed in claim 4, wherein the controller is used for controlling a storage operation of the memory based on the noise level signal.

6. The surveillance system as claimed in claim 4, wherein the memory stores the captured images when the noise intensity in the monitored area is greater than the predetermined sound intensity.

7. The surveillance system as claimed in claim 3, wherein the controller further comprises a light controller element connected to the light source, the light controller element being configured for turning on the light source if the sound compared result indicates that the noise intensity in the monitored area is greater than the predetermined sound intensity.

8. The surveillance system as claimed in claim 7, wherein the light controller element is a field effect transistor.

9. The surveillance system as claimed in claim 3, wherein the controller comprises brightness comparator, the brightness comparator being configured for comparing the brightness signal with a predetermined brightness, and generating brightness-compared result; the sound detector is enabled if the brightness-compared result indicates that the brightness of the monitored area is lower than the predetermined brightness.

10. The surveillance system as claimed in claim 1, wherein the controller comprises:
a mode adjust module for classifying the brightness signal, and generating grades of the brightness signal;
a light driver for receiving the grades, and driving the light source to emit light with brightness corresponding to the grades.

11. A surveillance method, comprising:
detecting brightness of a monitored area;
emitting light to the monitored area according to the brightness of the monitored area;
capturing images of the monitored area; and
storing the images of the monitored area.

12. The surveillance method as claimed in claim 11, further comprising:
comparing the brightness of the monitored area with a predetermined brightness; and
emitting the light to the monitored area if the brightness of the monitored area is lower than the predetermined brightness.

13. The surveillance method as claimed in claim 11, further comprising:
classifying the brightness of the monitored area into a plurality of grades; and emitting the light to the monitored area according to the grades of the brightness of the monitored area.

14. The surveillance method as claimed in claim 11, further comprising:
detecting a noise intensity in the monitored area; and
emitting the light to the monitored area according to the noise intensity in the monitored area.

15. The surveillance method as claimed in claim 14, further comprising:
comparing the noise intensity in the monitored area with a predetermined sound intensity; and
emitting the light to the monitored area if the noise intensity in the monitored area is greater than the predetermined sound intensity.

16. The surveillance method as claimed in claim 14, further comprising:
comparing the brightness of the monitored area with a predetermined brightness; and
detecting a noise intensity in the monitored area if the brightness of the monitored area is lower than the predetermined brightness.

17. The surveillance method as claimed in claim 14, further comprising:
comparing the noise intensity in the monitored area with a predetermined sound intensity; and
storing the image of the monitored area if the noise intensity in the monitored area is greater than the predetermined sound intensity.
